(19) United States
(12) Patent Application Publication
(10) Pub. No.: US 2026/0111788 A1
(43) Pub. Date: Apr. 23, 2026

(54) MODELS USING DIRECT AND INDIRECT FEEDBACK

(71) Applicant: Adobe, Inc., San Jose, CA (US)

(72) Inventors: Xiang Chen, Palo Alto, CA (US); William George, Pleasant Grove, UT (US); Wei Zhang, Great Falls, VA (US); Uttaran Bhattacharya, Sunnyvale, CA (US); Tong Yu, Fremont, CA (US); Sungchul Kim, San Jose, CA (US); Said Kobeissi, Lovettsville, VA (US); Ryan A. Rossi, Santa Clara, CA (US); Ritwik Sinha, Cupertino, CA (US); Razvan Alexandru Balan, Bucharest (RO); Prithvi Bhutani, Lynnwood, WA (US); Michael Young, San Jose, CA (US); Michael Edwin Rimer, Lindon, UT (US); Md Mehrab Tanjim, Santa Clara, CA (US); Jordan Walker, Lehi, UT (US); Jiabin Geng, San Jose, CA (US); Iftikhar Ahamath Burhanuddin, Bangalore (IN); Guillaume Escarguel, San Jose, CA (US); Brandon Mooso, South Jordan, UT (US); Abhisek Trivedi, South Jordan, UT (US)

(21) Appl. No.: 18/919,052

(22) Filed: Oct. 17, 2024

(51) Int. Cl. G06N 20/00

(52) U.S. Cl. CPC G06N 20/00

(57) ABSTRACT

In various examples, direct and indirect feedback is obtained and used to update a machine learning model. For example, feedback indicating interactions with the machine learning model are obtained from various entities. Continuing this example, the feedback is used to determine a set of scores associated with a particular response generated by the machine learning model. In various embodiments, the set of scores includes a response score, a multi-turn score, and a session score. Furthermore, the set of scores, in this examples, are combined to generate a single score associated with the response that is then used to update the machine learning model.

### BACKGROUND

Users often rely on analytics services to collect and analyze data. Such analytics services can provide insights based on analyzed data. Users, in particular, use analytics services to conduct analytics sessions on data (e.g., user clickstream data) while attempting to gain insights. By way of example, an analytics service can answer questions, such as which mobile devices make the most product conversions. The analytics service can also quantify the success of a marketing campaign. However, a user (e.g., a data analyst) of the analytics services must make many decisions when it comes to gathering insights from an increasing amount of data and capabilities in processing the data, and the user needs to have the ability to quickly query, analyze, and draw inferences from the data. As such, machine learning models are useful tools that when integrated into the analytics service can help users gather insights by filtering, collecting, reviewing, or otherwise interacting with the data and capabilities of the analytics services.

### SUMMARY

Embodiments of the present disclosure are directed towards providing an improved workspace assistant model (e.g., a machine learning model such as a large langue model or neural network) in an analytics service where various types of direct and indirect feedback are used to update or otherwise improve the workspace assistant model. In various embodiments, the analytics service includes an analytics engine and an analytics client including a workspace assistant. In one example, the workspace assistant provides user's an interface to access or otherwise interact with one or more machine learning models that are integrated with the analytics engine. Continuing this example, the one or more machine learning models aid the user by obtaining natural language prompts from the user and processing input data based on the natural language prompts to generate content (e.g., summaries, charts, graphs, visualizations, or other information generated by a machine learning model) and providing the content to the analytics client such that the user is able to review the content and determine insights. In various embodiments, the workspace assistant model generates a query to the analytics engine and processes the result to generate a graph or other visualization within the analytics client (e.g., a workspace or other user interface element displayed by the analytics client) based on a natural language prompt provided by a user.

Furthermore, in various embodiments, direct and indirect feedback is obtained and used to update the workspace assistant model. In one example, the user can provide direct feedback such as a “thumbs-up” via a user interface element within the analytics client. In some embodiments, indirect feedback can be obtained based on the user's interaction with the analytics client. For example, the user saving and returning to a particular workspace generated by the workspace assistant model or sharing the particular workspace with another user is used as indirect feedback to update the workspace assistant model. In various embodiments, the direct and indirect feedback obtained by the analytics service or component thereof (e.g., the analytics engine, the analytics client, data store, workspace assistant tool, or other services integrated with the analytics service) are used in a function to update a machine learning model.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a feedback data store obtains feedback from a plurality of sources, in accordance with at least one embodiment.

FIG. 3 depicts an environment in which a combined score for a response generated by a machine learning model is determined based on feedback, in accordance with at least one embodiment.

FIG. 4A depicts a screenshot of a user interface of an application illustrating feedback, in accordance with at least one embodiment.

FIG. 4B depicts a screenshot of a user interface of an application illustrating feedback, in accordance with at least one embodiment

FIG. 5 depicts an example process flow for updating a machine learning model using scores determined based on feedback, in accordance with at least one embodiment.

FIG. 6 is a block diagram of a Large Language Model that uses particular inputs to make particular predictions, according to some embodiments.

FIG. 7 is a block diagram of an exemplary computing environment suitable for use in implementations of the present disclosure.

### DETAILED DESCRIPTION

Various terms are used throughout this description. Definitions of some terms are included below to provide a clearer understanding of the ideas disclosed herein

As used herein, the term “feedback” refers to data obtained from various sources that provide explicit or implicit information indicating user satisfaction with a response generated by a machine learning model. For example, the feedback includes direct feedback such as prompting the user to provide information indicating user satisfaction associated with a response or indirect feedback such as the user sharing a response with other users. The feedback includes various signals that are, in one example, associated with a value that is used to generate a score associated with the response. In various embodiments, the feedback includes both direct and indirect signals or other data collected and used to improve the machine learning model. In one example, the workspace assistant tool collects user interactions happening both in a workspace assistant and a workspace of an application, which are combined together to provide additional insight into user behavior and satisfaction associated with responses, visualizations, and/or other information provided by the machine learning model. There are certain actions, for example, that indicate a strong attitude towards a response, such as, if in the workspace assistant, the user chooses to copy a response or add a response to the workspace. Continuing this example, such actions shows a strong agreement with the result and, alternatively, if the user decides to the change or delete the response generated by the machine learning model, this feedback indicates that the user disagrees with the result.

As used herein, the term “feedback data store” refers to a storage device, storage service, component of a service (e.g., a analytics service), database, application, and/or combination thereof that collects, stores, or otherwise maintains feedback obtained from a plurality of sources. For example, the feedback data store can include a variety of computer-readable media. Computer-readable media can be any available media that can be accessed by computing device and includes both volatile and nonvolatile media, removable and non-removable media. By way of example, the computer storage media includes computer-readable media for storage of feedback. The feedback data store, in various embodiments, stores feedback in both structure (e.g., database, key value store, index, etc.) or unstructured formats. In addition, in some embodiments, the feedback data store is implemented as a service including a frontend for obtaining storage requests and a backend for processing storage requests and storing data. In one example, the feedback data store is implemented as a data streaming service and obtains data from a plurality of sources and process the data to extract the feedback. In other embodiments, the feedback data store is implemented as database or other data store that obtains feedback from the plurality of sources.

As used herein, the term “analytics service” refers to cloud computing services that provide users access to data that is used to generate insights. For example, the analytics service collects, processes, and provides operations that help users gain insights and make decisions. In one example, the analytics service collects marketing campaign data and allows users to process this data to gain insights into successful marketing campaigns. Furthermore, the analytics service, for example, is accessible to the user through an application and can perform various operations using the data to generate content that enable users to determine insights associated with the data. In an embodiment, the analytics service is a service that is capable of tracking, measuring, and analyzing data, such as website traffic and customer behavior. In one example, the analytics service provides user access to a workspace that is used to interaction with data maintained by the service. In this way, an analytics service may collect or obtain data from various channels, such as websites, mobile applications, videos, social media, etc. Continuing with this example, through the workspace, the user can interact with the analytics service and break down, filter, query, and visualize data. As such, the analytics service may provide real-time data analysis such that various insights related to user interactions, campaign performance, and/or content engagement may be viewed. Various features of an analytics service may include, by way of example only, user journey analysis and conversion analysis (e.g., in association with particular channels or campaigns), predictive insights (e.g., forecasting trends or issues), customized metrics to enable tailored information, and/or the like.

As used herein, the term “workspace” refers to a user interface element of an application that allows a user to cause various operations to be performed. By way of example, the workspace can include a canvas, project view, or other interface that allows a user of the application to view and interact with content such as content generated by a machine learning model. Continuing this example, the user provides a query to the machine learning model which, in response, populates the workspace with content such as graphs, visualizations, summaries, or other content to allow the users to gain insights from the content displayed in the workspace. In various embodiments, the workspace includes an area of the application allowing users to interact with features and tools provided by the application and/or analytics service. For example, the workspace includes various user interface elements such as: a toolbar that contains icons and menus for various tools and functions; a canvas area where content (e.g., content generated by the machine learning model) is displayed, edited, and interacted with; panels and/or sidebars that provides additional options, settings, and/or information; a status bar displaying information such as a zoom level, cursor position, or other details; navigation controls such as scroll bars, zoom controls, or other controls; and context menus that provide context-specific options.

As used herein, the term “workspace assistant” refers a user interface element of an application that allows a user to interact with a machine learning model. By way of example, the workspace assistant includes a chat or other interface that allows the user to submit queries (e.g., natural language questions) and obtain responses generated by a machine learning model. Continuing this example, the workspace assistant provides an interactive interface allowing users to conduct natural language conversations with the machine learning model to facilitate the processing of data maintained by the analytics services to determine insights. In various embodiments, the workspace assistant includes various user interface elements to facilitate interactions with the machine learning model such as: a message area where queries from the user and response from the machine learning model are displayed; an input box to provide natural language queries and/or prompts; a send button to submit natural language queries and/or prompts; and a thumb-up and/or thumbs-down button to provide direct feedback.

As used herein, the term “workspace assistant tool” refers a to an application service, or other executable code that is integrated with the analytics services and provides a machine learning model that generates content based on input from the user and data maintained by the analytics service. For example, the workspace assistant tool is integrated into the application (e.g., through the workspace assistant user interface element) and the analytics service allowing the user to provides queries through the workspace assistant of the application, and in turn, the workspace assistant tool cause the machine learning model to generates responses, visualizations, and/or other information using data provided by the analytics service. In various embodiments, the workspace assistant tool provides prediction, summaries, natural language responses, charts, graphs, visualizations, or other generated content in response to a user question, command, or other prompt that is also in natural language.

As used herein, the term “response score” refers to a combination of values associated with a particular response generated by a machine learning model. For example, various types of feedback are associated with various values which are combined to generate the response score. Continuing this example, as feedback is obtained the values associated with the feedback are used to update or otherwise generate the response score. In one example, the response score is generated based on values assigned to particular feedback such as a user interaction with an application or component thereof such as a workspace or workspace assistant.

As used herein, the term “multi-turn score” refers to a combination of values associated with a set of responses generated by a machine learning model. For example, as the user submits additional queries, a relationship between the queries is determined and a score for the set of queries is determined. Continuing this example, the machine learning model determines that two or more queries are related to the same subject matter and/or topic and a value is assigned to each interaction based on this relationship.

As used herein, the term “session score” refers to a combination of values associated with a particular session with the analytics service. For example, feedback such as the user returning to a previously saved session and/or ending a session after an interval of time is used to determine a score associated with a session. In another example, a machine learning model determines a sentiment associated with user interactions with the machine learning model and associates a value with the sentiment to generate the session score.

The term “insight” is used herein to refer to information identifying a meaningful understanding, pattern, trend, correlation, or data relationship obtained by analyzing user data that can be used to inform decisions and actions. While user data can generally be considered raw data, insights provide structured information from analysis of the raw data. For example, graphs or visualizations of the raw data show trends over an interval of time.

A “query” refers to text that is used as input to a machine learning model that instructs the machine learning model to produce specific content based on data maintained by the analytics service. In one example, a query is obtained from the user and a prompt to the machine learning model is generated based on the query. In other examples, the query is provided directly to the machine learning model as the prompt.

The term “content” is used herein to refer to content generated by a machine learning model in response to a query and/or prompt. For example, content can include summaries, graphs, charts, visualizations, and/or other information displayed in a user interface to aid the user in determining insights. The content, for example, includes information generated by a machine learning model based on a prompt and/or other input to the machine learning model.

In modern cloud computing environments, users often rely on analytics services to collect and analyze large amounts of data collected from various data streams and services. Such analytics services can provide insight about customers, products, web-site traffic, or trends based on analyzed data. Users, in particular, use analytics services to conduct analytics sessions on user data (e.g., user clickstream data) while attempting to gain insight into a customer's activity and purchasing behavior. A vast amount of data can be gathered that relates to customers and web traffic of a business (e.g., search trends, product sales, marketing, etc.). Such data can relate to a wide variety of web traffic behaviors.

Analytics services are typically employed to process the vast amount of data to assist in decision-making (e.g., targeted marketing campaigns). Often, analytics systems attempt to analyze and understand how customers interact with a webpage (e.g., number of webpage visits, which kind of device a customer uses to interact with a company webpage when purchasing a product, whether a webpage visit leads to product conversion, etc.). A wide variety of insights into interactions with a webpage are of interest to a business (e.g., customer web traffic, sales in response to marketing campaign, types of devices completing sales, etc.).

There has been growth in the use of analytics services because of the increase in data gathered from different data domains. Existing analytics services provide numerous tools and capabilities to a user (e.g., data analyst) so that they can generate and visualize insights of interest from the observed data. For example, analysts using data-centric software need to make several selections within an analytics application to achieve certain objectives, gather insights from the data and take downstream decisions. Considering the sheer volume of data to be analyzed, there is now a demand on systems to query, analyze, and draw inferences while limiting any delay in accessing the data or performing processing operations. However, the high complexity and large number of commands and capabilities in analytics systems can be a drawback to an analyst that only needs a subset of these actions to perform an intended analysis objective or a novice analyst in need of guidance as to productive analysis.

New tools including machine learning models, such as large language models (LLMs), are trained and used to interact with the analytics service to allow the user to generate content and determine insights based on natural language queries. Moreover, there are several varieties of conventional analytics services that operate based on analyzing natural language. Analyzing natural language queries supports the effective understanding of users' queries to automate the discovery of insights from data. Such conventional systems, however, fail to provide or otherwise include an efficient and effective way to re-train, fine-tune, or otherwise improve these machine learning models. Generally, in this regard, conventional implementations do not leverage integration across a wide variety of applications and services to use both direct and indirect feedback to improve these machine learning models. As such, the technical solution of inventive functionality of the present disclosure is feedback signals based in part on improving the responses and/or other content generated by machine learning models.

Because human activity is often language based, natural language phrases can improve a user's ability to interact with a software application; however, these capabilities need to be refined and improved in order to improve the user experience and provide content relevant to the user. As illustrated in the technical solution, obtaining direct and indirect feedback and generating data based on that feedback to improve the machine learning models enables and improves the use of natural language to interact with the application and provides improvements over existing solutions. At a high level, both direct and indirect feedback can be obtained from the machine learning models, the analytics service or other services, and the application so that a set of scores are determined and used to improve the machine learning models. The technical solution generates a combined score and a set of individual scores for various types of feedback signals and uses a reward function or other function to update the machine learning models (e.g., modify weights, parameters, or other component of the machine learning models).

By way of context, the quality of responses can vary depending on the user and analytics service, and it is difficult to improve the responses generated by these machine learning models. For example, two major limitations when trying to improve these solutions include 1) low user engagement rate on feedback and 2) user tendency to only provide feedback on significantly positive or negative responses and/or generated content. Furthermore, these conventional solutions treat each response independently of prior exchanges with the machine learning models and do not include other possible feedback information. In other words, these conventional solutions have limited feedback mechanisms for improving the machine learning models.

Analytics services have not been developed with adequate assistant models, or, in other words, the current combination of analytics applications and artificial intelligence driven assistant models do not provide a technical solution that addresses the limitations of improvement via training features and/or fine-tuning in conventional analytics application. For example, these conventional systems rely on analysts providing feedback directly. Additionally, this data is very limited and does not include many other data sources that could improve these assistant models. With that, it has become impractical for analytics services and/or application to effectively and efficiently improve these assistant models once integrated into the application or service.

In contrast, embodiments described herein combine feedback systems tailored to a workspace user interface and assistant models. For example, various types of direct and indirect feedback, including retention-based (e.g. retrospective) feedback, follow-up and/or clarifying question-based feedback, and feedback related to actions taken in the workspace user interface are used to generate a plurality of scores that can be used to effectively and efficiently improve the assistant models. Furthermore, in various embodiments, the different types of feedback signals are assigned different weights and then combined into a single score. For example, scores for a single response generated by the assistant model, scores for multi-turn responses, and session scores are generated, which allows for a determination of the quality of generated responses in a broader way and enables specific improvements to be implemented.

Accordingly, embodiments described herein generally relate to obtaining various direct and indirect feedback signals in order to improve the accuracy and relevance of responses and/or of machine learning models integrated into an application for interacting with an analytics service. In accordance with some aspects, the systems and methods described are directed to a workspace assistant model that provides responses to user queries through a workspace of the application that allows the user to perform analytics via the analytics service to determine various insights.

Embodiments of the technical solution can be explained by way of examples with reference to an analytics application that provides users with access to an analytics service with additional details provided below in the Specification with reference to corresponding illustrations. For example, the analytics service is used to track, report, analyze, and visualize various types of data. Continuing this example, the analytics service and/or analytics application includes an assistant model that obtains natural language queries from the user and generates a response that includes content such as visualizations and/or other data that can be used to determine insights.

In various embodiments, a plurality of different feedback signals are obtained, by a feedback data store, from a plurality of different sources and used to generate a set of scores and/or a combined score that is used to update or otherwise improve the performance of the machine learning model. For example, retention feedback is obtained from the analytics service based on users returning to or otherwise interacting with content generated by the machine learning model over a plurality of session and/or an interval of time. Another example of feedback obtained include user actions performed in the workspace of the application. In particular, user interactions in modifying, saving, deleting, or otherwise performing an action with content generated by the machine learning model is collected and/or stored as feedback associated with the machine learning model.

In yet other examples, the feedback includes interactions with the workspace assistant such as direct feedback (e.g., clicking on a “thumbs-up” icon) and/or user communication with the machine learning model through the workspace assistant. Lastly, another example of feedback includes feedback obtained or other generated by the workspace assistant tool. Continuing this example, the feedback includes a sentiment associated with a query or an indication that two or more queries are related. In various embodiments, once the feedback is obtained a set of score is determined by at least assigning a value to specific feedback. Furthermore, in such embodiments, a combined score is determined by at least combing the set of score to determine the combined score which is used in a function (e.g., reward function) to update or otherwise improve the machine learning model.

As described, conventional technology does not adequately collect feedback from separate sources and relies on feedback provided directly from the user. Furthermore, as mentioned above, such feedback is limited, inconsistent, and only relevant to a small portion of the content generated by machine learning models. As a result, the machine learning model integrated into conventional analytics services are difficult to improve and/or fine-tune and are not adequately adapted to user preferences and/or user behavior.

Advantageously, embodiments described herein obtain feedback from a plurality of sources and used to improve the machine learning models integrated in to analytics services. For example, obtaining, from multiple sources, these various types of direct and indirect feedback, including retention-based (e.g. retrospective) feedback, follow-up and/or clarifying question-based feedback, and feedback related to actions taken in the application better captures the user experience and/or user satisfaction with the machine learning model. In addition, in various embodiments, the feedback is used to improve the accuracy and relevance of responses generate by the machine learning model. For example, by obtaining implicit and/or indirect feedback in combination with direct feedback from the user, the machine learning model can be improved (e.g., by determining a score based on the feedback and using the score in a function to modify weights of the machine learning model) based on user behavior and, in turn, be improved and/or adapted to generate content that better matches user expectations and/or preferences. In this manner, data from distinct sources that can be used to improve the machine learning model is efficiently collected and maintained in a single location, allowing for scores to be and used to improve the machine learning model. Furthermore, embodiments described herein provide for improved training, fine-tuning, or otherwise updating machine learning models based on various types of feedback including implicit and explicit feedback signals.

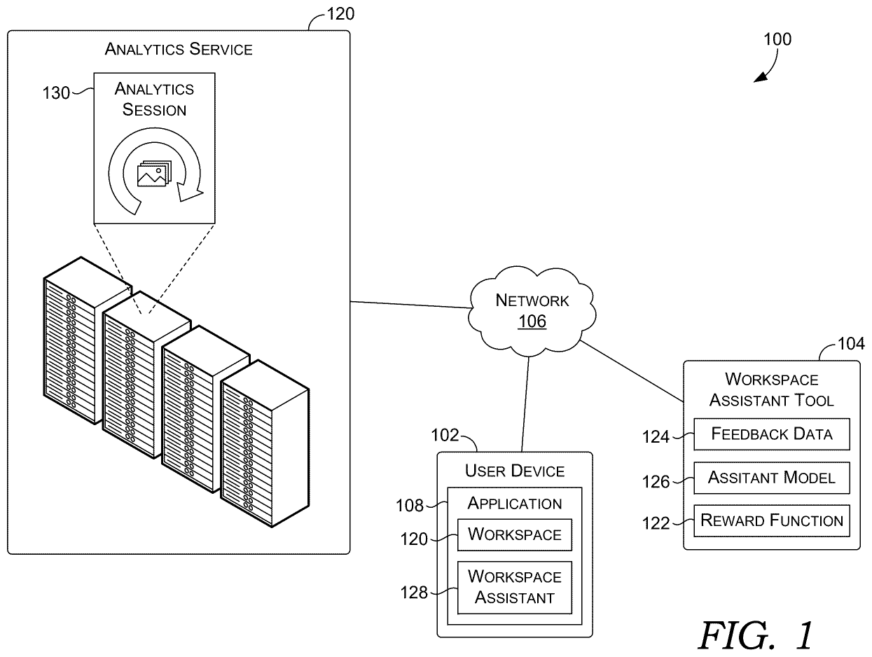

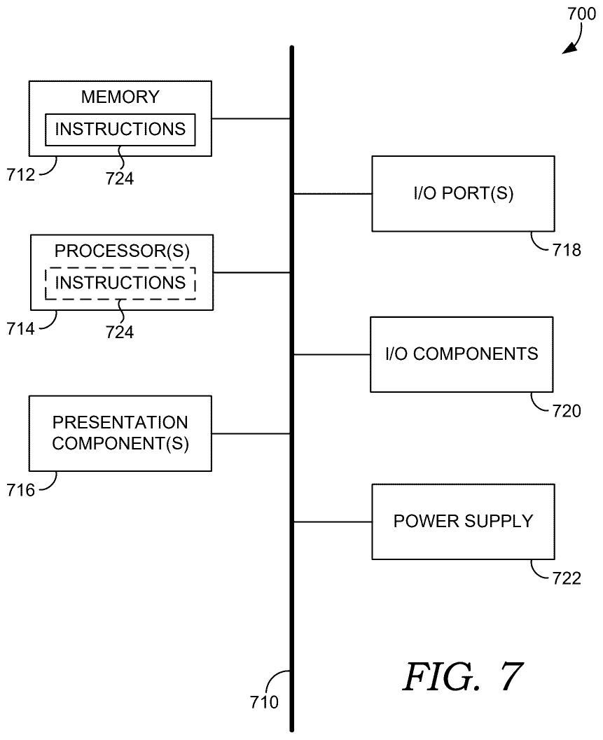

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 7.

It should be understood that operating environment 100 shown in FIG. 1 is an example of one suitable operating environment. Among other components not shown, operating environment 100 includes a user device 102, workspace assistant tool 104, an analytics service 132, and a network 106. Each of the components shown in FIG. 1 can be implemented via any type of computing device, such as one or more computing devices 700 described in connection with FIG. 7, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the workspace assistant tool 104 includes multiple server computer systems cooperating in a distributed environment to perform the operations described in the present disclosure.

User device 102 can be any type of computing device capable of being operated by an entity (e.g., individual or organization) and provides queries to the workspace assistant tool 104 and/or obtains data (e.g., responses, content, visualizations, etc.) facilitated by the workspace assistant tool 104 (e.g., a server operating as a frontend). The user device 102, in various embodiments, has access to or otherwise interacts with the analytics service 132. For example, the application 108 communicates over the network 106 with the analytics service 132 to allow the user, through a workspace 120 of the application 108, to access an analytics session 130. Continuing this example, the analytics session 130 allows the user to interact with data and perform various data analytics operations to determine various insights from the data.

In some implementations, user device 102 is the type of computing device described in connection with FIG. 7. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice and/or one or more services.

In various embodiments, the application 108 includes any application capable of facilitating the exchange of information between the user device 102, the analytics service 132, and the workspace assistant tool 104. For example, the application 108 provides queries to an assistant model executed by the workspace assistant tool 104. In another example, the application 108 provides feedback data 124 to the workspace assistant tool 104, which then uses the feedback data 124 to update the assistant model 126 using a reward function 122. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and the analytics service 132. In some cases, the application 108 is integrated into the operating system (e.g., as a service). It is therefore contemplated herein that “application” be interpreted broadly. Some example applications include ADOBE® Customer Journey Analytics, a cloud-based analytics service.

For cloud-based implementations, for example, the application 108 is utilized to interface with the functionality implemented by the workspace assistant tool 104 and/or the analytics service 132. In some embodiments, the components, or portions thereof, of the workspace assistant tool 104 are implemented on the user device 102 or other systems or devices. For example, the workspace assistant 128 includes an interface for providing natural language queries to the workspace assistant tool 104. Furthermore, in some embodiments, the workspace assistant tool 104, components, or portions thereof, are implemented by the analytics service 132 or other cloud service provider. Thus, it should be appreciated that the workspace assistant tool 104, in some embodiments, is provided via multiple devices arranged in a distributed environment that collectively provide the functionality described herein. Additionally, other components not shown can also be included within the distributed environment.

As illustrated in FIG. 1, the workspace assistant tool 104 is integrated into the application 108 and the analytics service 132 through the application 108. For example, the user provides queries through a user interface (e.g., the workspace assistant 128) of the application 108, and in turn, the application 108 provides the queries to the workspace assistant tool 104, which, using the assistant model 126, generates responses, visualizations, and/or other information using data and operations provided by the analytics service 132. In various embodiments, the workspace assistant 128 provides an interface for predicting, generating, or providing one or more natural language responses in response to a user question, command, or other prompt that is also in natural language.

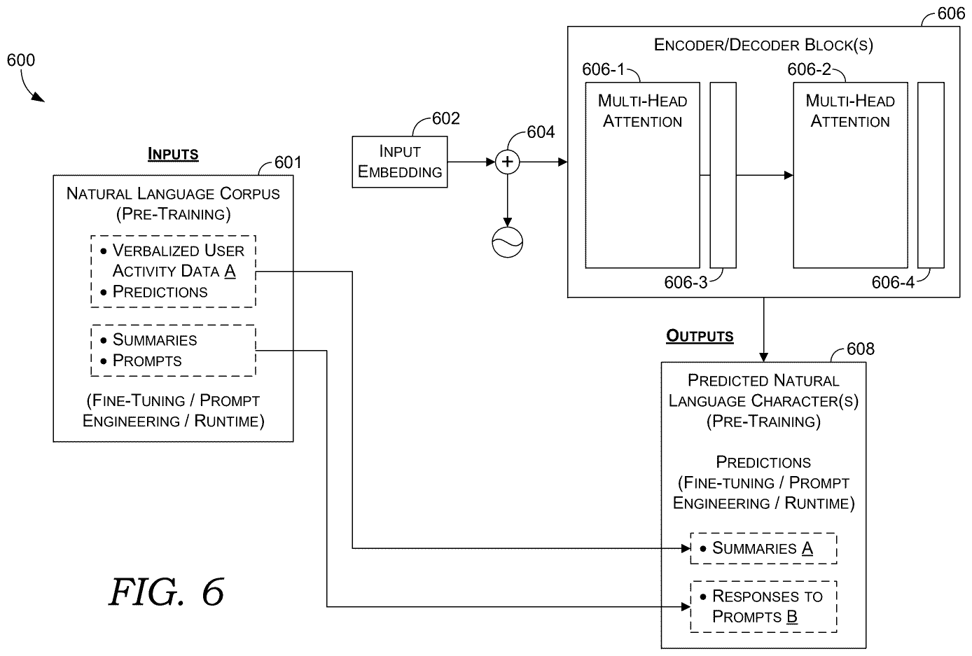

In some embodiments, the workspace assistant 128 is or uses the assistant model 126 to perform various operations. In one example, the assistant mode includes a large language model (LLM) as described in greater detail below in connection with FIG. 6 trained to provide responses (e.g., answers) to user commands or questions, such as via prompt engineering, as described in more detail below. When a data analyst, for example, asks a question (e.g., sends a voice command or provides user input) through the workspace assistant 128, the application 108 transmits the query to the workspace assistant tool 104 (e.g., a compute node with an LLM) and then the workspace assistant tool 104 retrieves/accesses the relevant information from the analytics service 132 and formulates and provides an appropriate response back to the workspace assistant 128. In various embodiments, the workspace assistant 128 allows the user to copy and share the natural language responses, add the natural language to the workspace 120, and/or undo a previously applied update to the workspace generated by the assistant model 126.

In various embodiments, the feedback data 124 includes both direct and indirect signals or other data collected by the workspace assistant tool 104 to improve the assistant model. In one example, the workspace assistant tool 104 collects user interactions happening both in the workspace assistant 128 and the workspace 120, which are combined together to provide additional insight into user behavior and satisfaction associated with the response, visualizations, and/or other information provided by the assistant model 126. There are certain actions, for example, that indicate a strong attitude towards a response, such as, if in the workspace assistant 128, the user chooses to copy a response or add a response to the workspace 120 that shows a strong agreement with the result. Continuing this example, alternatively, if the workspace assistant 128 updates the workspace 120 and the user decides to undo the change, this feedback indicates that the user disagrees with the result.

In various embodiments, the feedback data 124 includes data collected or otherwise obtained from the analytics services 120 or other service. For example, user retention data obtained from the analytics service 132 is also an important indicator to improve the assistant model 126. In particular, the more the user interacts with the workspace assistant, in various embodiments, is an indicator that the user is satisfied with the quality of the responses generated by the assistant model 126. Other types of feedback data 124 collected by the workspace assistant tool 104 include a length of the analytics session 120, a number of questions asked, and other metrics associated with the analytics session 120. In one example, follow-up questions in the workspace assistant 128 are used to indirectly evaluate the quality of the responses for the previous questions. Continuing this example, whether the user asks a follow-up question, a clarification question, or starts a separate line of questioning are all used to provide feedback data 124 related to the previous questions and responses provided by the assistant model 126. In various embodiments, based on the context, the workspace assistant tool 104 can infer the relationship between the new question and the previous question(s) and assign a value to the previous response that can be used in the reward function 122 to update the assistant model 126. In one example, the assistant model 126 determines if queries are related to determine if a particular feedback item contributes to a particular multi-turn score.

In various embodiments, the feedback data 124 includes user sentiment. For example, a sentiment attention layer is added to the cross-modal attention encoder, and a sentiment classifier identifies one or more sentiments from output of the sentiment attention layer. In an embodiment, the workspace assistant tool 104 determines that a particular question has a negative sentiment based on the sentiment detection determining that the user is attempting to fix an error associated with a response from the previous question. In other embodiments, the workspace assistant tool 104 determines that a particular response has the positive sentiment as a result of the user building on or otherwise expanding the previous question.

In various embodiments, the feedback data 124 includes implicit and explicit feedback collected from various locations. Furthermore, in various embodiments, the reward function 122 includes multiple formulas that are utilized to calculate various scores for different levels (e.g., response, multi-turn, and the analytics session 130 level) and then combined or otherwise used to contribute to a combined score for responses generated by the assistant model 126.

In various embodiments, scores are determined and/or updated as the user interacts with the analytics service 132 through the application 108 (e.g., the workspace 120 and/or the workspace assistant). For example, the action of the user saving the workspace 120 causes the system to generate a score for the action of saving the workspace 120, which causes the combined score for the analytics session 130 to be modified based on the score. Continuing this example, as a result of the user returning to the saved workspace 120, a new score for the action of returning to the saved workspace 120 is determined and used to update the score for the analytics session 130. In various embodiments, scores are updated based on retention data or other data obtained from the analytics service 132. In various embodiments, scores are reset in response to a certain signal being received and/or after an interval of time.

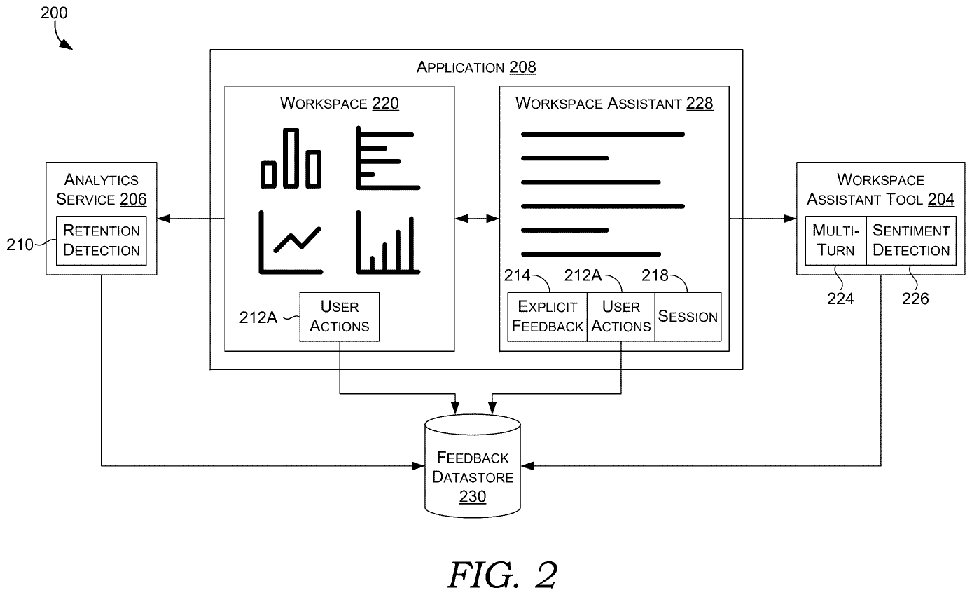

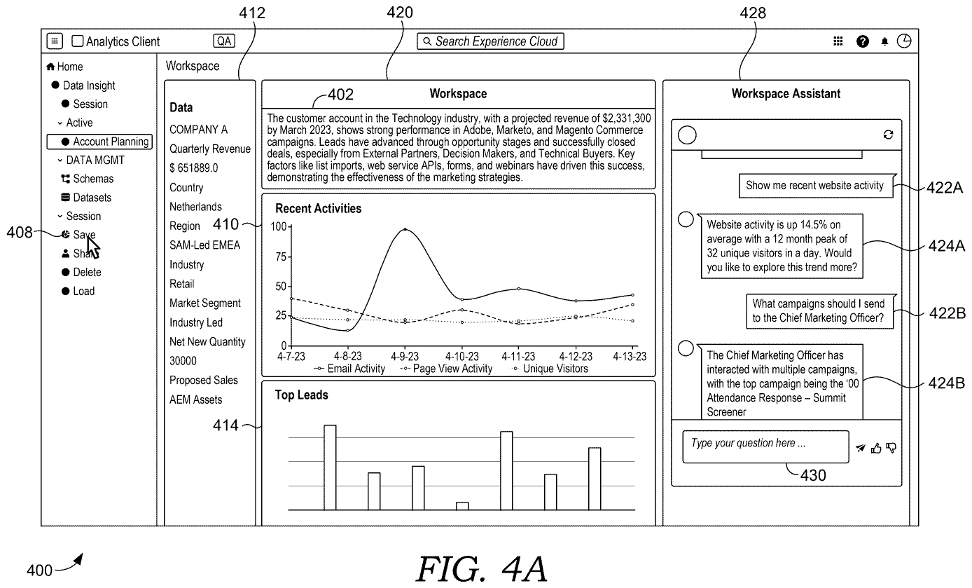

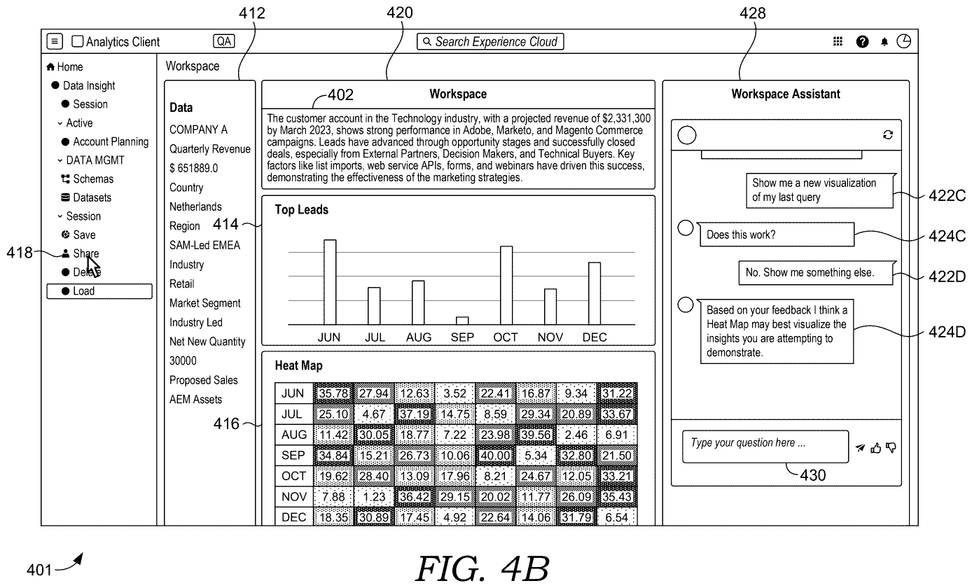

FIG. 2 is a diagram of an environment 200 in which an application 208 allows users to interact with an analytics service 206 in order to determine insights from data in accordance with an embodiment. In various embodiments, the analytics service 206 allows users to interact with data maintained by the analytics service 206 or other services and generates charts, visualizations, summaries, or other information to aid the user in determining insights. Furthermore, the application 208, in an embodiment, includes a workspace 220 which provides a user interface to allow the user to view and interact with information obtained and/or generated by the analytics service and a workspace assistant 228 which provides the user with an interface to a machine learning model (e.g., assistant model 126) to submit queries and obtain response. For example, the workspace 220 includes a canvas or other user interface element that displays charts and visualizations to a user, and the workspace assistant 228 provides a user interface element that accept queries and displays responses such as the user interface 400 described in detail below in connection with FIG. 4.

In an embodiment, the analytics service 206 obtains retention detection 210 feedback based on user interactions with the application 208, which is provided to a feedback data store 230. The feedback data store 230, in an embodiment, obtains feedback from a plurality of locations, entities, data streams, or other sources, which can be used by a workspace assistant tool 204 to update the machine learning model used to generate responses and other information displayed in the workspace 220 and the workspace assistant 228. For example, the feedback data store 230 obtains a data streaming service that maintains a plurality of data streams. In some embodiments, the feedback data store 230 is integrated into another component such as the analytics service 206 or workspace assistant tool 204. As illustrated in the environment 200, the feedback data store 230 obtains feedback from retention detection 210 feedback, user actions 212A within workspace 220 of the application 208, user actions 212B within workspace assistant 228 of the application 208, explicit feedback 214, session 218 feedback, multi-turn 224 feedback, and sentiment detection 226 feedback.

In various embodiments, various different feedback signals include data, metadata, or other information indicating direct or indirect feedback associated with the machine learning model of the workspace assistant tool 204. For example, as a result of users interacting with the application 208 and causing a new chart, a new visualization, an update to an existing chart or visualization, or other information within the workspace 220 and/or workspace assistant to be displayed feedback is determined and provided to the feedback data store 230. In one example, the explicit feedback 214 includes user satisfaction ratings such as a thumbs-up/down, a like, a flag, or other information provided directly from the user. In another example, the explicit feedback 214 includes qualitative feedback such as open-ended feedback from users on their experience with the workspace assistant tool 204 or component thereof, such as the machine learning model.

In various embodiments, the user actions 212A and 212B include various actions and/or operations that the user can perform with the application 208. For example, the user actions 212A and 212B include any number of actions that are performed based on an operation and/or capability of the application including: saving, editing, copying, and/or sharing responses; bookmarking a question and/or a response; undoing a previous update to the workspace 220 performed by the workspace assistant tool 204 or component thereof such as the machine learning model; adding a response from the workspace assistant 228 to the workspace 220; selecting, inputting, or otherwise providing a clarification question; and selecting, inputting, or otherwise providing a follow-up question.

In various embodiments, the session 218 feedback includes feedback associated with a session of the application 208, such as the analytics session 130 described above in connection with FIG. 1. For example, the session 218 feedback includes a duration of a user interaction with the workspace assistant 228, a number of questions and/or queries provided by the user to the workspace assistant 228, or other information associated with a session of the application 208. In an embodiment, the feedback includes metrics that are collected to infer the user's satisfaction such as positive and negative feedback. In one example, positive feedback includes user edits to a created and/or modified visualization generated by the workspace assistant tool 204 or component thereof, such as the machine learning model. In another example, positive feedback includes saving and/or sharing a session that contains components, charts, content, visualizations, summaries, or other data generated by the workspace assistant tool 204 or component thereof, such as the machine learning model. Examples of negative feedback include deleting, modifying, and/or undoing changes to components, charts, content, visualizations, summaries, or other data generated by the workspace assistant tool 204 or component thereof, such as the machine learning model. Another example of negative feedback includes closing a session of the application 208 without saving components, charts, content, visualizations, summaries, or other data generated by the workspace assistant tool 204 or component thereof, such as the machine learning model.

In various embodiments, the analytics service 206 obtains retention detection 210 feedback by at least detecting or otherwise determining whether a user is new to the workspace assistant tool 204 or a returning user, and, if the user is a returning user, determining the last time the user used the workspace assistant tool 204. In one example, if the user is a returning user, retention detection 210 feedback indicates whether the user has used workspace assistant tool 204 during the current session, and how frequently the user uses the workspace assistant tool 204 compared to other manual actions. In various embodiments, the retention data (e.g., feedback related to user interactions with previous workspaces) provides an indication of the user's satisfaction with the content generated by the workspace assistant tool 204.

In some embodiments, retention detection 210 feedback includes indirect feedback from the analytics service 206. For example, the indirect feedback obtained from the analytics service includes user interactions with content generated by the workspace assistant tool 204, such as returning to a particular workspace, sharing the particular workspace, deleting the particular workspace, or otherwise interacting with previously generated content. In some embodiments, the retention detection 210 feedback includes direct feedback, in addition to the indirect feedback, collected or otherwise obtained from the user interacting with the analytics service 206 through the application 208.

In various embodiments, the workspace assistant tool 204 determines or otherwise collects multi-turn 224 feedback, which represents feedback from a plurality of related questions and/or response and sentiment detection 226 feedback which represents the users sentiment associated with a particular response or set of responses. In one example, the workspace assistant tool 204 maintains the context of the questions and/or queries submitted through the workspace assistant 228 and determines a multi-turn score indicating the quality of previous responses based on the new query. In various embodiments, the machine learning model determines the multi-turn score based at least in part on the questions and/or queries submitted through the workspace assistant 228. In a first example, the user gets a response from the workspace assistant tool 204 and then selects or asks a follow-up question, and the machine learning model then generates a multi-turn score that indicates that the user is satisfied with the previous response. In another example, the user selects a clarification question from the list provided by workspace assistant tool 204, and the machine learning model then generates a multi-turn score that indicates that the user is satisfied with the clarification question presented in the list. In yet another example, the user types in a clarification (e.g., the machine learning model determines that the next question is related to the previous question), and the machine learning model then generates a multi-turn score that indicates that the response or the list of clarification questions did not satisfy the user's expectations. Furthermore, in various embodiments, as new clarification questions are selected or otherwise provided by the user (e.g., the user is continuing the line of questioning), the multi-turn score is updated.

In various embodiments, the machine learning model determines a sentiment associated with queries provided by the user and provides the determined sentiment as sentiment detection feedback 226. For example, the machine learning model, using a sentiment detection layer, determines that a clarification question indicates a negative sentiment associated with the previous response and provides an indication to the feedback data store 230 as sentiment detection 226 feedback. In some embodiments, the sentiment detection 226 is determined for a set of queries and responses, or for a single query and response.

In various embodiments, if the user provides a new line of questioning (e.g., a question that the machine learning mode determines is not relevant to the previous questions), then the multi-turn score is considered completed and is provided to the feedback data store 230 as multi-turn feedback 224. Furthermore, in some embodiments, the new line of questioning indicates that the user is satisfied with the previous responses, and the multi-turn score for the previous responses is updated. In various embodiments, the feedback obtained by the analytics service 206, application 208, and/or workspace assistant tool 204 is provided as a stream of data to the feedback data store 230 and scores of various types of feedback are generated and/or updated as data is obtained, periodically or aperiodically. For example, a score for each user action 212A and 212B is generated in response to detecting the user actions 212A and 212B, and a score for the session is generated once the user has terminated the current session. In other examples, the score for the session is initialized at the start of the session and updated as feedback is obtained.

As additional feedback is obtained, in various embodiments, scores associated with the feedback are modified and/or adjusted. In addition, in response to scores being updated, the machine learning model of the workspace assistant tool 204 is updated and/or retrained in accordance with an embodiment. For example, a reward function takes the scores as an input and updates weights of the workspace assistant model.

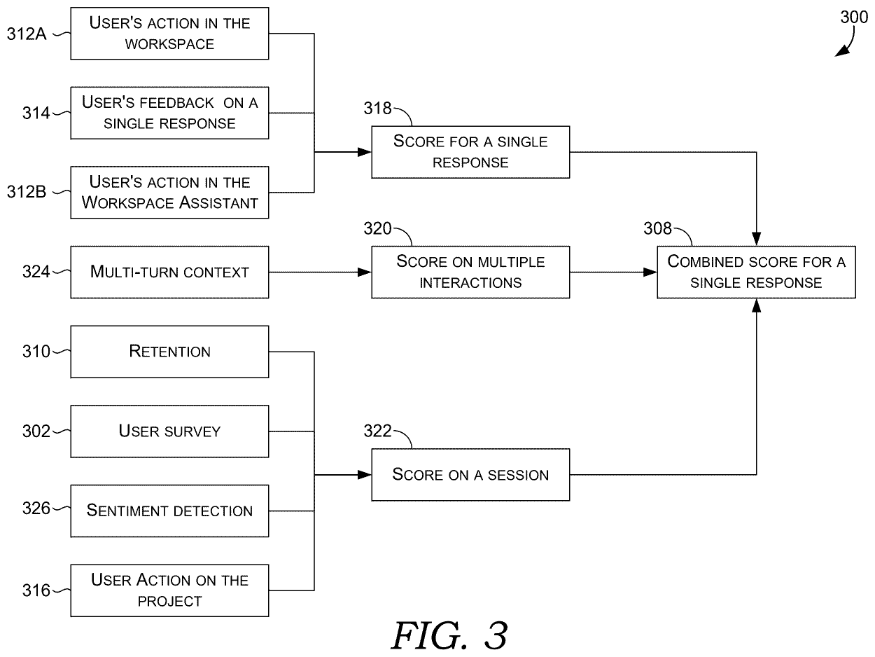

FIG. 3 is a diagram of an environment 300 in which a set of scores and a combine score is determined for a response generated by a machine learning model based on direct and indirect feedback obtained from various sources in accordance with an embodiment. In various embodiments, the set of scores and the combined score are used in a function to update the machine learning models (e.g., modify the weights associated with the machine learning model). In the example illustrated in FIG. 3, the combined score for a single response 308 includes a score for a single response 318, a score on multiple interactions 320, and a score on a session 322. Furthermore, in this example, the score for a single response 318, the score on multiple interactions 320, and the score on a session 322 comprise a plurality of scores that individually contribute to the corresponding score and the combined score for a single response 308.

In particular, in various embodiments, the score for a single response 318 includes the user's action in the workspace 312A, the user's feedback on a single response 314, and the user's action in the workspace assistant 312B. For example, a user modifying content generated by the machine learning model in the workspace as well as the user providing a direct feedback (e.g., selecting the thumbs up icon in the user interface) are combined to generate the score for a single response 318. In an embodiment, the multi-tune contextual information generated by the machine learning model is used to generate the score on multiple interactions 320. For example, as a result of the machine learning model determining that a query is related to a previous query and/or response as a score is associated with the multi-turn context 324 and used to generate the score on multiple interactions 320.

In various embodiments, the score of a session 322 includes a retention score 310, a user survey score 302, a sentiment detection score 326, and a user action on the project score 316. Each of the scores illustrated in FIG. 3 can be used individually or various combinations and sub-combinations of the scores can be used to update the machine learning model. (e.g., the assistant model 126 described above). Furthermore, in various embodiments, the values in the table below can by dynamically adjusted. For example, if multiple “thumbs-up” feedback signals are obtained in succession, the value for subsequent “thumbs-up” signal is modified. Continuing this example, a weight assigned to the category of feedback (e.g., “score for single response”) can be adjusted in response to the multiple feedback signals. Furthermore, various scores can be determined or otherwise calculated without some or all of the scores. For example, the session score 322 is determined despite a user not having completed a survey and therefore not having the user survey score 302.

In various embodiments, once all the data has been collected from different sources, the feedback data store 230 processes the feedback and determines or otherwise calculates the scores for the responses generated by the machine learning model. In addition, in various embodiments, different types of feedback can contribute to the score associated with a single response, multiple responses, or an entire session. An example table below illustrates possible scores that can be assigned to various feedback types and/or other data used to update the model.

| | | Score for | Score for | | |
|---|---|---|---|---|---|
| Type of | | Single | Multi-turn | Score for the | |
| Feedback | Action | Response | Interaction | Session | Source |
| Direct | Thumbs up | 1 | | | Workspace |
| Feedback | | | | | Assistant |
| Direct | Thumbs down | −1 | | | Workspace |
| Feedback | | | | | Assistant |
| Direct | Report | −1 | | | Workspace |
| Feedback | | | | | Assistant |
| Actions in | Undo button | −0.8 | | | Workspace |
| panel | | | | | Assistant |
| Actions in | Bookmark an | 0.8 | | | Workspace |
| panel | answer | | | | Assistant |
| Actions in | Share/Copy | 0.8 | | | Workspace |
| panel | button | | | | Assistant |
| Actions in | Add to | 0.8 | | | Workspace |
| panel | Chart/Project | | | | Assistant |
| | button | | | | |
| Actions in | Undo | −0.2 | | | Workspace |
| canvas | | | | | |
| Actions in | Add new | 0.2 | | | Workspace |
| canvas | components | | | | |
| | to AI | | | | |
| | generated | | | | |
| | report | | | | |
| Actions in | Delete AI | −0.2 | | | Workspace |
| canvas | generated | | | | |
| | report | | | | |
| Actions in | Save project | | | 0.8 | Workspace |
| canvas | with AI | | | | |
| | generated | | | | |
| | report | | | | |
| Actions in | Close project | | | −0.2 | Workspace |
| canvas | without | | | | |
| | saving | | | | |
| Multiturn | Select a | | 0.2 | | Workspace |
| questions | follow up | | | | Assistant |
| | question | | | | |
| Multiturn | Select a | | 0.1 | | Workspace |
| questions | clarification | | | | Assistant |
| | question | | | | |
| Multiturn | Input a | | −0.4 | | Workspace |
| questions | clarification | | | | Assistant Tool |
| | question | | | | |
| Multiturn | Input a new | | 0.5 | | Workspace |
| questions | related | | | | Assistant Tool |
| | question | | | | |
| Multiturn | Input an | | 0.4 | | Workspace |
| questions | unrelated | | | | Assistant Tool |
| | question | | | | |
| Retention | Come back to | | | 0.2 to all the | Analytics |
| | AI panel | | | preview | Service |
| | | | | sessions in the | |
| | | | | last 7 days | |
| Retention | Come back to | | | −0.05 to all the | Analytics |
| | workspace but | | | preview | Service |
| | not using AI | | | sessions in the | |
| | to curate the | | | last 7 days | |
| | project | | | | |
| Session | Ask more | | | 0.3 | Analytics |
| Length | than 5 | | | | Service |
| | questions | | | | |
| | before closing | | | | |
| | the panel | | | | |
| Session | Ask fewer | | | −0.1 | Analytics |
| Length | than 5 | | | | Service |
| | questions | | | | |
| | before closing | | | | |
| | the panel | | | | |
| Sentiment | Positive | | | 0.2 | Workspace |
| analysis | | | | | Assistant Tool |
| Sentiment | Negative | | | −0.5 | Workspace |
| analysis | | | | | Assistant Tool |

For example, using the table as an example above, a score can be determined using the following formula:

$$combinedScore = fn ( responseScore , multiturnScore , sessionScore ) ;$$

Furthermore, in some embodiments, weights can be used in the formula to attribute appropriate values to specific feedback based on various factors such as application, need, environment, experience, or other factors. For example, the equation can be adjusted as:

$$combinedScore = responseScore * 0.5 , multiturnScore * 0.3 , sessionScore * 0.2 ;$$

In an example score using the equation above, the user starts a session, opens a new project, provides a first query, obtains a first response generated by the machine learning model, and then copies the response. Continuing this example, the user then provides a second question, obtains a second response, then asks a follow-up question, obtains a follow up response, and selects the thumbs-up icon in the user interface. Finally in this example, the user saves the session and returns to it at a point later in time to initiate a second session and provide additional queries and obtain additional responses. In this example, the combined score for a single response 308 is determined for each response described above based on values associated with the feedback indicated in the table (e.g., a value of one for a thumbs-up feedback signal) and combined using a formula such as the formulas above.

FIG. 4A is a screenshot 400 of an example user interface page of an application that provides a workspace 420 and a workspace assistant, according to some embodiments. The screenshot 400 includes the data 412, a summary 402, a save 408 user interface element, a chart 410, a bar graph 414, and a workspace assistant 428, which provides a query box 430 user interface element to allow users to submit queries 422A and 422B to a workspace assistant tool (e.g., the workspace assistant tool 104 described above in connection with FIG. 1). Furthermore, in some embodiments, a machine learning model of the workspace assistant tool provides responses 424A and 424B. In some embodiments, the application allows users to interact with an analytics service and determine insights based on the summary 402, the chart 410, and/or the bar graph 414 generated by the machine learning model of the workspace assistant tool.

In various embodiments, feedback is obtained based on interactions with the user and the application. As illustrated in FIG. 4A, feedback is obtained based on the user selecting the save 408 user interface element with the cursor and causing the project to be saved by the analytics service and/or application. This type of feedback is an example of indirect feedback. In other examples, direct feedback is provided by the thumbs-up and thumbs-down user interface elements illustrated in the screenshot 400. Furthermore, additional feedback is determined based on a relationship between query 422A and 422B. For example, as a result of query 422B being unrelated to query 422A, feedback is inferred corresponding to the response 424A. In this example, a positive inference is determined that the user is satisfied with the response 424A based on the query 422B being unrelated to query 422A.

FIG. 4B is a screenshot 401 of the example user interface of FIG. 4A that includes additional interactions that provide additional feed. In various embodiments, the screenshot 401 represent a continuation of the session represented by screenshot 400. For example, the user saved the session represented by screenshot 400 and, at some later time, caused the saved session to be loaded and resumed interacting with the data saved in the session. The screenshot 401 includes a share 418 user interface element, a heat map 416, additional queries 422C and 422D, and additional responses 424C and 424D. In various embodiments, the user selecting the share 418 user interface element causes the application to provide feedback (e.g., to the feedback data store) indicating the user action. For example, as described above, the user action is used as feedback to the feedback data store, which then assigns a value to the user action and determines a score and/or set of scores based on the feedback.

Furthermore, in various embodiments, the relationship between the additional queries 422C and 422D and additional responses 424C and 424D is used to determine feedback such as multi-turn feedback and sentiment feedback. In one example, the machine learning model determines based on query 422D that the user is not satisfied with the previous response (e.g., the bar graph 414) and provides an indication of the feedback to the feedback data store. In addition, feedback associated with the response 424D, for example, is determined and used to update the machine learning model (e.g., assigns more weight to heat maps when similar queries to query 422C are submitted).

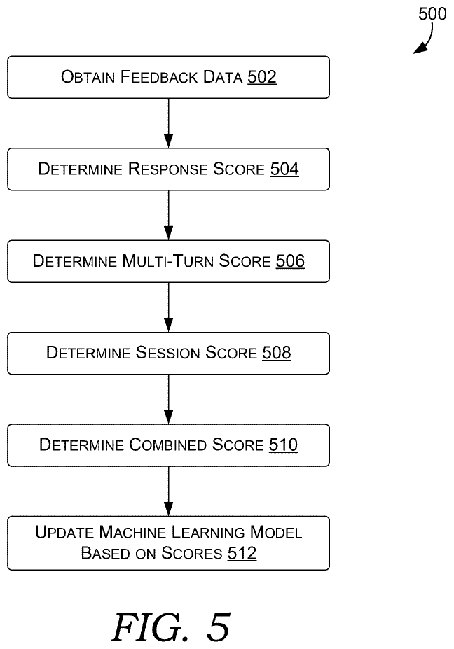

FIG. 5 is a flow diagram showing a method 500 for updating a machine learning model based on direct and indirect feedback obtained from a plurality of sources in accordance with at least one embodiment. The method 500 can be performed, for instance, by the workspace assistant tool 104 of FIG. 1 and/or the feedback data store 230 of FIG. 2. Each block of the method 500 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, the system implementing the method 500 obtains feedback data. As described above in connection with FIG. 2, in various embodiments, feedback is obtained by the feedback data store from an analytics service, application, and workspace assistant tool based on direct and indirect action of the user when interacting with one of the analytics service, application, and workspace assistant tool. For example, the user performs an action in the application and the application provides an indication of the action to the feedback data store.

At block 504, the system implementing the method 500 determines a response score. For example, feedback data associated with the response such as a user action in the workspace or workspace assistant, as described above in connection with FIG. 3, is used to generate the response score. At block 506, the system implementing the method 500 determines a multi-turn score for the response. In one example, the machine learning model determines that a set of clarifying questions are associated with the response and determines a multi-turn score associated with the set of clarifying questions.

At block 506, the system implementing the method 500 determines a session score. For example, as described above, the action of the user saving the session and/or the machine learning model determining a sentiment associated with the user queries are used as feedback to determine a score for the session. Furthermore, in various embodiments, values are associated with various types of feedback such as described with the table above. In other embodiments, values for the feedback are determined dynamically based on a formula and/or algorithm.

At block 510, the system implementing the method 500 determines a combined score. For example, the combined score is determined using a formula that includes the scores determined at blocks 504, 506, and 508. Various combinations and subcombinations of scores can be determined and used to update the model in accordance with an embodiment. At block 512, the system implementing the method 500 updates the machine learning model based on the score. For example, the workspace assistant tool uses a reward function or other function to update the machine learning model using the scores.

FIG. 6 is a block diagram of a Large Language Model 600 (e.g., a bidirectional encoder representations from transformers [BERT] model or generative pre-trained transformers [GPT] model such as GPT-4) that uses particular inputs to make particular predictions (e.g., answers to questions), according to some embodiments. In some embodiments, this model 600 represents or includes the functionality as described with respect to the assistant model 126 and/or the chat interface of the workspace assistant 128 of FIG. 1. In various embodiments, the language model 600 includes one or more encoders and/or decoder blocks 606 (or any transformer or portion thereof).

First, a natural language corpus (e.g., various WIKIPEDIA English words or BooksCorpus) of the inputs 601 are converted into tokens and then feature vectors and embedded into an input embedding 602 to derive meaning of individual natural language words (for example, English semantics) during pre-training. In some embodiments, to understand English language, corpus documents, such as text books, periodicals, blogs, social media feeds, and the like, are ingested by the language model 600.

In some embodiments, each word or character in the input(s) 601 is mapped into the input embedding 602 in parallel or at the same time, unlike existing long short-term memory (LSTM) models, for example. The input embedding 602 maps a word to a feature vector representing the word. However, the same word (for example, “apple”) in different sentences may have different meanings (for example, phone versus fruit). This is why a positional encoder 604 can be implemented. A positional encoder 604 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

$$\begin{matrix}P {E}_{( p o s , 2 i )} = sin ( pos / 1000 {0}^{2 i / {d}_{m o d e l}} ) \\ {PE}_{( p o s , 2 i + 1 )} = cos ( pos / 1000 {0}^{2 i / {d}_{m o d e l}} ) .\end{matrix}$$

After passing the input(s) 601 through the input embedding 602 and applying the positional encoder 604, the output is a word embedding feature vector, which encodes positional information or context based on the positional encoder 604. These word embedding feature vectors are then passed to the encoder and/or decoder block(s) 606, where it goes through a multi-head attention layer 606-1 and a feedforward layer 606-2. The multi-head attention layer 606-1 is generally responsible for focusing or processing certain parts of the feature vectors representing specific portions of the input(s) 601 by generating attention vectors. For example, in question answering systems, the multi-head attention layer 606-1 determines how relevant the i^{th} word (or particular word in a sentence) is for answering the question or how relevant it is to other words in the same or other blocks, the output of which is an attention vector. For every word, some embodiments generate an attention vector, which captures contextual relationships between other words in the same sentence or another sequence of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K or V}} ) \cdot V .$$

For multi-headed attention, there are multiple weight matrices W^{q}, W^{k}, and W^{v} so that there are multiple attention vectors Z for every word. However, a neural network may only expect one attention vector per word. Accordingly, another weighted matrix, W^{z}, is used to make sure the output is still an attention vector per word. In some embodiments, after the layers 606-1 and 606-2, there is some form of normalization (for example, batch normalization and/or layer normalization) performed to smoothen out the loss surface, making it easier to optimize while using larger learning rates.

Layers 606-3 and 606-4 represent residual connection and/or normalization layers where normalization recenters and rescales or normalizes the data across the feature dimensions. The feedforward layer 606-2 is a feedforward neural network that is applied to every one of the attention vectors output by the multi-head attention layer 606-1. The feedforward layer 606-2 transforms the attention vectors into a form that can be processed by the next encoder block or make a prediction at 608. For example, given that a document includes first natural language sequence “the due date is . . . ” the encoder/decoder block(s) 606 predicts that the next natural language sequence will be a specific date or particular words based on past documents that include language identical or similar to the first natural language sequence.

In some embodiments, the encoder/decoder block(s) 606 includes pre-training to learn language and makes corresponding predictions. In some embodiments, there is no fine-tuning because some embodiments perform prompt engineering, prompt-tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn such that a second output (indicative of high likelihood of being the correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand that language and fine-tuning are performed to learn a specific task, such as learning an answer to a set of questions (in question answering systems). In some embodiments, the encoder/decoder block(s) 606 learns what language and context for a word is in pre-training by training on two unsupervised tasks (masked language model [MLM] and next sentence prediction [NSP]) simultaneously or at the same time. In terms of the inputs and outputs, at pre-training, the natural language corpus of the inputs 601 may be various historical documents, such as text books, journals, and periodicals, in order to output the predicted natural language characters in 608 (not make the predictions at runtime or prompt engineering at this point). The encoder/decoder block(s) 606 takes in a sentence, paragraph, or sequence (for example, included in the input[s] 601), with random words being replaced with masks. The goal is to output the value or meaning of the masked tokens. For example, if a line reads, “please [MASK] this document promptly,” the prediction for the “mask” value is “send.” This helps the encoder/decoder block(s) 606 understand the bidirectional context in a sentence, paragraph, or line in a document. In the case of NSP, the encoder/decoder block(s) 606 takes, as input, two or more elements, such as sentences, lines, or paragraphs, and determines, for example, if a second sentence in a document actually follows (for example, is directly below) a first sentence in the document. This helps the encoder/decoder block(s) 606 understand the context across all the elements of a document, not just within a single element. Using both of these together, the encoder/decoder block(s) 606 derives a good understanding of natural language.

In some embodiments, during pre-training, the input to the encoder/decoder block(s) 606 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 602). At the output side is the binary output for the next sentence prediction. For example, this component may output 1, for example, if masked sentence 2 follows (for example, is directly beneath) masked sentence 1. The output is word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 601) that are encoded into a vector (for example, first sentence, second sentence, etc., assuming a top-down and right-to-left approach). The position embeddings are vectors that represent the position of a particular word in such a sentence that can be produced by positional encoder 604. When these three embeddings are added or concatenated together, an embedding vector is generated that is used as input into the encoder/decoder block(s) 606. The segment and position embeddings are used for temporal ordering since all of the vectors are fed into the encoder/decoder block(s) 606 simultaneously and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 606 performs prompt engineering or fine-tuning on a variety of datasets by converting different formats into a unified sequence-to-sequence format. For example, some embodiments perform the task by adding a new question answering head or encoder/decoder block, just the way a masked language model head is added (in pre-training) for performing an MLM task, except that the task is a part of prompt engineering or fine-tuning. This includes the encoder/decoder block(s) 606 processing the inputs 601 (i.e., the verbalized user activity data, the predictions, summaries, and/or prompts) in order to make the predictions and confidence scores as indicated in 608. Prompt engineering, in some embodiments, is the process of crafting and optimizing text prompts for language models to achieve desired outputs. In other words, prompt engineering is the process of mapping prompts (e.g., a question) to the output (e.g., an answer) that they belong to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or more examples (e.g., one-shot or two-shot examples).

In an illustrative example, in some embodiments, the predictions of the output 608 may be generative text, chart, graphs, or other visualizations, such as those described above with FIGS. 4A and 4B. Alternative to prompt engineering or fine-tuning, in some embodiments the inputs 601 and outputs 608 represent “runtime” inputs and outputs. Runtime represents a time after which the model 600 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets—and an inference phase, which includes making predictions, classifications, or generating outputs for real-world tasks or queries.

Unlike convolution neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters, with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing unit [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Having described embodiments of the present disclosure, FIG. 7 provides an example of a computing device in which embodiments of the present disclosure may be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 7 and make reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built-in. Illustrative components include a microphone, joystick, game pad, satellite dish, scanner, printer, wireless device, etc. I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 may be equipped with depth cameras, such as stereoscopic camera systems, infrared camera systems, RGB camera systems, and combinations of these, for gesture detection and recognition. Additionally, computing device 700 may be equipped with accelerometers or gyroscopes that enable detection of motion. The output of the accelerometers or gyroscopes may be provided to the display of computing device 700 to render immersive augmented reality or virtual reality.

Embodiments presented herein have been described in relation to particular embodiments, which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. An AI-based analytics service system, comprising
a workspace assistant tool having:
a machine learning model; and
an interface element that obtains queries through a workspace assistant of an application and provides responses to the queries, wherein the responses are generated by the machine learning model based on data maintained by an analytics service; and
a feedback data store that stores feedback indicating user interactions with the machine learning model, wherein the feedback includes at least one of: a first feedback obtained from the analytics service indicating retention data associated with a session of the application; a second feedback obtained from the application indicating a user action performed within a workspace of the application; a third feedback associated with a response generated by the machine learning model and obtained from the workspace assistant; or a fourth feedback from the workspace assistant tool generated by the machine learning model.

2. The medium of claim 1, wherein the third feedback includes explicit feedback provided by a user through the workspace assistant.

3. The medium of claim 2, wherein the explicit feedback provided by the user includes information indicating an interaction with a first user interface element for providing direct positive feedback or a second user interface element for providing direct negative feedback.

4. The medium of claim 1, wherein the user action performed within the workspace of the application includes at least one of: modifying the response, deleting the response, saving the response, sharing the response, and not saving the response.

5. The medium of claim 1, wherein the fourth feedback includes an indication that a query provided by the user through the workspace assistant is related to a previous query that caused the machine learning model to provide a previous response.

6. The medium of claim 5, wherein the query is selected by the user through the workspace assistant of the application and is provided by the machine learning model as a clarification query to the previous query.

7. The medium of claim 5, wherein the fourth feedback indicates a determination by the machine learning model that the previous query and the query are related.

8. The medium of claim 1, wherein the workspace assistant tool further comprises:
a reward function that obtains a set of scores that include a response score based on the second feedback and the third feedback, a multi-turn score based on the fourth feedback, and a session score based on the first feedback; and
wherein a parameter of the machine learning model is modified based on a combined score generated based on the set of scores.

9. A method comprising:
obtaining, from a feedback data store, feedback indicating user interactions with a workspace assistant model from at least one of an analytics service, an application, and a workspace assistant tool, where the workspace assistant model provides a response to a query through the application supported by the analytics service;
determining, by the workspace assistant tool, a response score associated with the response based on the feedback, a multi-turn score associated with a plurality of user interactions with the workspace assistant model based on the feedback, and a session score associated with a user session of the application based on the feedback;
determining, by the workspace assistant tool, a combined score for the response, the combined score based on the response score, the multi-turn score, and the session score; and
updating, by the workspace assistant tool, the workspace assistant model based on the combined score.

10. The method of claim 9, wherein the method further comprises updating the workspace assistant model based on at least one of: the combined score, the response score, the multi-turn score, and the session score.

11. The method of claim 9, wherein the method further comprises modifying at least one of: the combined score, the response score, the multi-turn score, and the session score based on additional feedback obtained after the feedback.

12. The method of claim 9, wherein the feedback includes at least one of: a first user action within a workspace of the application, a second user action within a workspace assistant of the application, explicit feedback, a sentiment associated with the query, a clarification query associated with the query, and retention information.

13. The method of claim 8, wherein determining the combined score for the response further comprises combining values associated with the feedback based on a first weight assigned to the response score, a second weight assigned to the multi-turn score, and a third weight assigned to the session score.

14. The method of claim 8, wherein the workspace assistant model is a large language model; and
updating the workspace assistant model based on the combined score further comprises using a reward function to modify weights associated with the large language model.

15. The method of claim 8, wherein the method further comprises obtaining additional feedback from the workspace assistant tool indicating that two or more user interactions of the plurality of user interactions with the workspace assistant model are related, where the workspace assistant model determines that the two or more user interactions are related.

16. A system comprising:
a memory component; and
a processing device coupled to the memory component, the processing device to perform operations comprising:
obtaining data indicating feedback associated with a response to a query generated by a machine learning model, the data obtained from at least one of an analytics service, an application, and a workspace assistant tool;
determining a response score associated with the response based on a first feedback included in the data and obtained from the application, a multi-turn score associated with the response based on a second feedback included in the data and obtained from the workspace assistant tool, and a session score based on third feedback included in the data and obtained from the analytics service;
determining a combined score for the response based on the response score, the multi-turn score, and the session score; and
updating the machine learning model based on the combined score.

17. The system of claim 16, wherein the second feedback indicates that the response to the query is related to at least one previous query.

18. The system of claim 16, wherein the second feedback is obtained from the application and indicates that a user selected a follow-up query displayed in the application.

19. The system of claim 16, wherein the third feedback indicates a user caused the application to load a previously saved session associated with the response.

20. The system of claim 16, wherein the third feedback indicates a sentiment associated with a set of queries provided by a user.
